(19) United States
(12) Patent Application Publication
(10) Pub. No.: US 2024/0227680 A1
(43) Pub. Date: Jul. 11, 2024

(54) OUTSIDE REARVIEW MINI CAMERA SYSTEM FOR ANY VEHICLE

(71) Applicant: Douglas A. Littleton, Daytona Beach Shores, FL (US)

(72) Inventor: Douglas A. Littleton, Daytona Beach Shores, FL (US)

(21) Appl. No.: 18/095,578

(22) Filed: Jan. 11, 2023

(51) Int. Cl. B60R 1/25; B60K 35/00

(52) U.S. Cl. CPC B60R 1/25; B60K 35/00; B60K 2370/1529; B60K 2370/176; B60R 2300/101; B60R 2300/802; B60R 2300/8046

(57) ABSTRACT

A mini camera system for replacing a motor vehicle outside rearview mirror is disclosed. The mini camera system comprises a housing secured to the door of the vehicle in place of a side view mirror. The mini camera system further comprises a camera arranged in the housing, wherein that camera is positioned to view a side portion and rear portion of the vehicle. The mini camera system also includes a blinker light arranged on the outside of the housing and a screen arranged on a dashboard or instrument cluster of the vehicle for viewing and displaying the left and right rear side views of the vehicle.

### BACKGROUND OF THE INVENTION

### 1. Field of the Invention

The present invention generally relates to a camera system for a vehicle outside rearview mirror and more particularly relates to a mini camera replacement system for use in place of any motor vehicle outside rearview mirrors.

### 2. Description of Related Art

Motor vehicles having outside rearview mirrors have been known for many years in the prior art. Generally, these outside rearview mirrors are arranged on an upper portion of both a passenger door and a driver door at or near the A pillar of a vehicle. These mirrors generally also have hardware inside the cabin of the motor vehicle near the driver's door to control the mirror in an up, down and left, right direction to position the mirror to the appropriate position for the size of the driver driving the automotive vehicle. These prior art outside rearview mirrors may also have a blinker light arranged either within the mirror or within the housing holding the mirror on both the passenger and driver side of the vehicle. The blinker may warn other drivers that the vehicle is about to move in either the left direction or right direction depending on which blinker is flashing in unison of the turn signal of the automotive vehicle. The prior art vehicles also may include wiring arranged between the outside rearview mirrors and the controls to move the mirrors in either an up, down or left, right direction. The wiring would also be connected to the control module of the vehicle in order to connect the blinker light to the blinker system of the automotive vehicle.

The prior art outside rearview mirrors did have many problems associated with them. Many of these prior art rearview mirrors may be broken by the hitting of the mirrors by other vehicles, persons or objects near the side of the vehicle. Many of these prior art outside rearview mirrors also were bulky and large in size and weighed too much for the vehicle. Furthermore, many of these prior art outside rearview mirrors required the drivers to turn their heads to see the status on the outside mirror and to check a blind spot, which occurred because of the placement and size of the mirrors with relation to the vehicle. Furthermore, many of these prior art outside rearview mirrors required many parts and wiring to keep the mirrors functioning in the manner prescribed by the automotive manufacturers.

Therefore, there is a need in the art for an improved outside rearview mirror. There also is a need in the art for a mini camera replacement system that may be used in lieu of an outside rearview mirror, such as those of the prior art. There also is a need in the art for a mini camera that also includes an LED blinker arranged within the housing of the mini camera system used to replace an outside rearview mirror. There also is a need in the art for a screen to be integrated into the instrument cluster or added on to the dashboard for viewing both a left side and a right side outside rearview mini camera. There also is a need in the art for a mini camera replacement system that may allow for reduced outside mirror breakage and also provides a weight savings with new smaller hardware versus the big bulky outside rearview mirrors of the prior art. There also is a need in the art for a mini camera replacement system that may be safer to use as the driver may simply look to the instrument cluster or screen arranged on the dashboard to view the right or left rear outside view surroundings of the motor vehicle. There also is a need in the art for the mini camera replacement system to remove any blind spots when viewing the left and right rear outside view of the motor vehicle.

### SUMMARY OF THE INVENTION

One object of the present invention may be that it provides an improved outside rearview system for a vehicle.

Another object of the present invention may be that it provides a mini camera system that is used as a replacement for outside rearview mirrors on a motor vehicle.

Still a further object of the present invention may be that it provides a mini camera replacement system that eliminates both the outside mirrors of a motor vehicle.

Another object of the present invention may be that it provides a mini camera system that also includes an LED blinker arranged in a housing thereof.

Still a further object of the present invention may be that it provides a mini camera replacement system that includes a screen that may display images on either the instrument cluster or a screen added onto a dashboard of a vehicle of both the left and right outside rear side views of the vehicle.

Yet another object of the present invention may be that it provides a mini camera system that includes either a concave or convex lens for viewing the side portions of the motor vehicle.

Still another object of the present invention may be that it provides a mini camera system that may have a driver control to focus the camera or move the camera in an up, down or left, right direction depending on the user of the camera.

Yet another object of the present invention may be that it provides a mini camera system for use on a vehicle that has a camera that is fixed in a predetermined position that is not capable of any movement.

Still another object of the present invention may be that it provides a more robust, cheaper to manufacture and install rearview camera system for a motor vehicle.

Still another advantage of the present invention may be to provide a mini camera system that reduces the need for the driver to turn their head to see the status shown in the outside mirror or to check a blind spot in either the left or right of a vehicle.

Yet another object of the present invention may be to provide a mini camera replacement system for a vehicle where the driver simply has to move their eyes to the instrument cluster to check the status of the left or right outside rear portion of the vehicle.

According to the present invention, the foregoing and other objects and advantages are obtained by a novel design for a mini camera system for use on a vehicle. The mini camera system comprises a housing secured to a door of the vehicle in place of a prior art sideview mirror. The mini camera system also includes a camera arranged in the housing, wherein that camera is positioned to view a side portion and rear portion of the automotive vehicle. The mini camera system also includes a blinker light arranged in the housing of the mini camera system. The mini camera system is arranged on both a driver side door and a passenger side door of the vehicle. The mini camera system may include a screen arranged in the instrument cluster or on the dashboard of the vehicle in order to display the left and right outside rearview of the motor vehicle to the driver of the vehicle without having the driver turn their head.

One advantage of the present invention may be that it provides for an improved rearview camera system for a vehicle.

Still another advantage of the present invention may be that it provides a mini camera replacement system for a vehicle in order to replace outside rearview mirrors thereof.

Yet another advantage of the present invention may be that it provides a mini camera replacement system that eliminates both outside mirrors on the passenger and driver side of a vehicle.

Yet another advantage of the present invention may be that it provides a mini camera system that also includes an LED blinker light arranged in the housing thereof.

Still another advantage of the present invention may be that it provides a mini camera system that includes a screen that is arranged in the instrument cluster or added on to a dashboard of the vehicle for viewing both the left and right outside rear directions of the motor vehicle by the driver of the vehicle.

Still another advantage of the present invention may be that it provides a mini camera system that may have a control button that focuses or moves the camera in an up and down direction and a left and right direction to accommodate various drivers of the vehicle.

Still another advantage of the present invention may be that it provides for a mini camera system that reduces the amount of hardware and wiring needed to operate the system and also reduces the potential of outside mirrors being broken while also creating a weight savings via new smaller hardware versus the big bulky outside prior art mirrors.

Still another advantage of the present invention may be that it provides for a mini camera replacement system that is safer to use than prior art outside mirrors as the driver of the vehicle does not have to turn their heads to see the status on the left or right side of the vehicle and adjacent areas thereto.

Other objects, features and advantages of the present invention may become apparent from the subsequent description and appended claims, taken in conjunction with the accompanying drawings.

### BRIEF DESCRIPTION OF THE DRAWINGS

FIG. 1 shows a back view of a prior art rearview mirror.

FIG. 2 shows a side view of a prior art outside rearview mirror.

FIG. 3 shows a view of an instrument cluster of the prior art.

FIG. 4 shows a plan view of a mini camera system for a vehicle according to the present invention.

FIG. 5 shows a side view of a mini camera rearview system for use in a vehicle according to the present invention.

FIG. 6 shows a screen of a mini camera rearview system arranged within the instrument cluster of a vehicle according to the present invention.

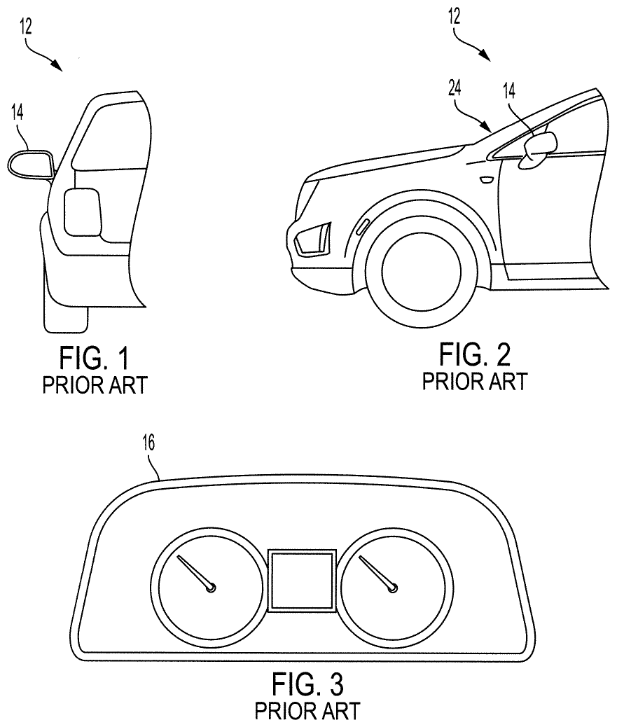

### BRIEF DESCRIPTION OF THE EMBODIMENT(S)

Referring to the drawings, there is shown a mini camera system 10 according to an embodiment of the present invention. The mini camera system 10 may be used on a vehicle 12 on both a driver's side door and passenger side door of the vehicle. It should be noted that it is contemplated that the mini camera system 10 may be used as a replacement for an automotive vehicle outside rear mirror, both the passenger side rearview mirror and the driver's side rearview mirror. However, it should be noted that the mini camera system 10 may be used on any type of vehicle, such as but not limited to a marine vehicle, a space vehicle, an aerospace vehicle, a motorcycle, ATV's, bicycles, or any other type of vehicle that needs to alert the driver to the rear side views of that vehicle 12 during driving thereof. The mini camera system 10 may replace both outside mirrors 14 of the vehicle 12 and thus eliminate the big bulky outside mirrors 14 and associated housings from the vehicles, thus reducing weight, increasing aerodynamics of the vehicle and eliminate the outside mirror's 14 ability to be subject to major damage. Furthermore, the use of the mini camera system 10 on a motor vehicle 12 instead of an outside rearview mirror 14 may allow for a reduction of broken outside mirrors 14, a weight savings because the hardware required for the mini camera system 10 is much smaller than the big bulky outside mirrors 14. Furthermore, the use of the mini camera system 10 in a vehicle 12 in place of the outside rearview mirrors 14 may create a safer environment for the driver of the vehicle 12, such that the driver does not have to turn their head to see the status on the outside mirror 14 of either the left or right side of the vehicle 12 and the driver does not have to turn their head to check the blind spot on both the left and right side of the vehicle 12. The blind spot of a vehicle 12 has been a major issue with drivers driving vehicles and the use of the mini camera system 10 of the present invention may reduce and/or eliminate a blind spot on the vehicle 12. Furthermore, the use of the mini camera system 10 on a vehicle 12 in place of the outside rearview mirrors 14 may allow for the driver to only have to simply move their eyes to the instrument cluster 16 to check the status and view the right or left outside rear facing portion of the vehicle 12.

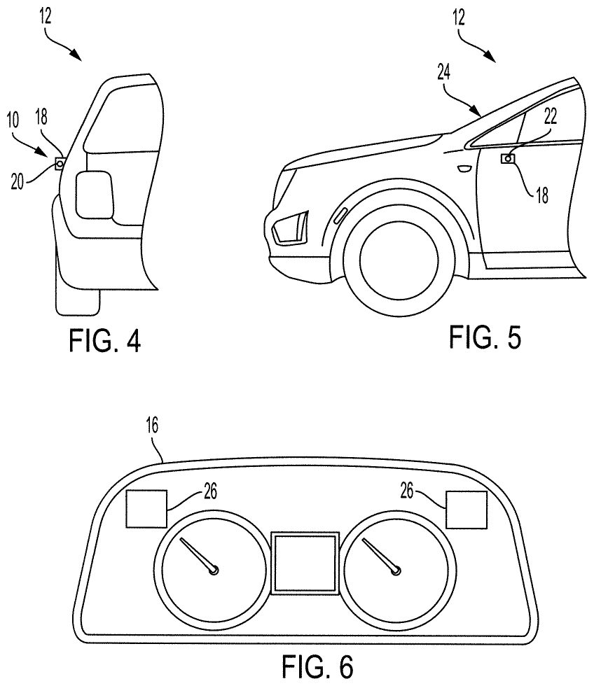

As shown in FIGS. 4 through 6, the present invention of a mini camera system 10, which is used as a replacement system for a motor vehicle outside rearview mirror 14 is shown. The mini camera system 10 includes a housing 18 secured to a door of the vehicle 12 as a replacement for or in place of a side view mirror 14. The mini camera system 10 also includes a camera 20 arranged within that housing 18. The mini camera system 10 also includes a blinker light 22 arranged within the housing 18. It should be noted that the housing 18 generally appears similar to a flasher light arranged on a large tractor trailer vehicle. In one contemplated embodiment, the housing 18 of the mini camera system 10 may be approximately two to four inches in length and approximately one to two inches wide. It should be noted that generally the housing 18 may be made of a metal material, such as steel or aluminum that the vehicle door is made of or it may be made of a plastic, ceramic, composite, manmade material or natural material, etc. The housing 18 may be secured to both the driver's side door and a passenger side door via any known mechanical or chemical fastening technique. In one contemplated embodiment, the housing 18 may be secured via a fastener to an outer door skin panel of the driver's side door and the passenger side door. It should be noted that any other technique, other than using a fastener such as epoxies, glue, welding, etc., may be used to secure a surface of the housing 18 to the outer shell of both the passenger door and the driver door. It should be noted that the mini camera system 10 generally may be arranged in the same area as the prior art outside rearview mirror 14 was on both the driver door and passenger side door. In one embodiment, the housing 18 of the mini camera system 10 may be arranged near a top edge of the driver and passenger door near the A pillar 24 of the vehicle 12. It should be noted that any other position on either the passenger door or the driver door or any of the other doors or quarter panels of both the passenger and driver's side of the vehicle 12 may also be used to secure the mini camera system 10 for use to replace the outside rear view mirrors. The housing 18 as shown in the drawings may have a generally rectangular shape when viewed from a side and a square like shape when viewed from the back of the vehicle 12. It should be noted that any other shape other than a rectangular and square shape shown may be used for the mini camera housing 18 such as but not limited to oval, triangular, circular, square, curved, or any other known shape may be used for the housing 18 of the mini camera system 10.

The housing 18 may also include an inner bore that may receive the camera 20 of the mini camera system 10 therein. The camera 20 may be secured such that the camera 20 faces a rear and side portion of the vehicle 12. It should be noted that the camera 20 may have any type of lens therein, however it is contemplated to use either a concave or convex lens for the mini camera 20. The camera 20 maybe capable of operating in the day or night. The lens may allow for a 3600 view from the camera 20 thus providing a complete view of the right and left side rear outer views and/or adjacent areas of the vehicle 12 without any blind spot occurring from either of the cameras 20 arranged within the housing 18 of the mini camera system 10. It is contemplated that the camera 20 may either be fixed with respect to the housing 18 or capable of moving with respect to the housing 18 to allow for the driver of the vehicle to move the camera 18 to a specific view to be shown on the interior of the cabin of the vehicle 12. If the camera 18 is capable of movement with respect to the housing 18 there would be a need for a control switch which would be arranged near the driver of the vehicle 12, either in the driver door, the instrument cluster 16 or a center console area of the vehicle. This control switch may allow the driver to either focus the camera 20 or to move the camera 20 in an up/down direction or left/right direction depending on the view the driver was specifically trying to achieve for the cameras 20. However, in the fixed camera option embodiment, any necessary wiring to control the movement of the camera 20 and focusing of the camera 20 would not be necessary as the camera 20 would be fixed in a predetermined position, thus showing the entire left and right side rear portions of the vehicle 10. This embodiment would eliminate the hardware and wiring needed to control the movement of the camera 20.

It should also be noted that the housing 18 may include a light 22 arranged therein, wherein the light is a blinker light 22. The blinker light 22 will be arranged behind a lens cover or any other cover that will allow the light 22 to shine from the housing 18. The blinker light 22 in one embodiment may be a LED type light bulb. The blinker light 22 may work in unison with the turn signal indicator of the vehicle and flash when the vehicle is turning in the direction that the camera 20 is arranged on or if a person enters the blind spot of the vehicle 12, the light may also come on to alert the driver if they look to that side view camera 20 on the outside of the vehicle 12. However, it should be noted that it is contemplated that the vehicle 12 may also identify on the instrument cluster or screen 26 associated with the mini camera system 10 if a person is in a blind spot of the vehicle via an icon or light shown on the screen 26 or flashed on the screen 26 to show such vehicle, person or object in the blind spot. The light shown on the screen 26 may be amber in color or another known color.

The camera 20 of the mini camera replacement system 10 may be any known camera that is capable of having a 3600 view from its aperture. The camera 20 in the present invention may be facing the rear/side portion of the vehicle 12 thus allowing for the driver of the vehicle 12 to see the entire side of the vehicle 12 back to and beyond the rear quarter panel along with the areas adjacent thereto and 360° from the front face of the housing 18, thus creating for a complete view of the side and rear of the vehicle from the camera 20 backwards. This view may occur on both the left and right outside of the motor vehicle 12. The camera 20 may either be connected via wiring or a wireless system to a screen 26 that is either integrated into the instrument cluster 16 of the vehicle 12 or added on to the dashboard of the vehicle 12. The screen 26 may either be a single screen that is split in half for viewing both the left and right outside rear views of the vehicle 12 or it may include two separate screens 26 for viewing the left outside rear view of the vehicle 12 and the right outside rear view of the vehicle 12. Thus, the instrument cluster 16 may include both a first and second screen 26 integrated therein with the first screen 26 showing the left view of the vehicle 12 and the second screen showing the right view of the vehicle 12 or may include a single screen that divides the screen 26 in half showing both the left and right view of the vehicle 12. It is also contemplated that the screen 26 may be added onto the dashboard as production or an aftermarket screen 26 to allow for retrofitting of prior art vehicles that have outside rearview mirrors into the mini camera replacement system 10 of the present invention. As noted above, the screens 26 may show both the left side view and the right side view facing towards the rear of the vehicle 12 that the outside rear view mirrors of present day now partially provide. Hence, any vehicle, person or object that enters the viewing range of the mini camera system 10 may be seen on the screen 26 within the cabin of the motor vehicle by the driver. It is also contemplated to use icons or lights along with or independent of audible warnings to alert the driver of objects in the viewing range of either the left side or right side camera 20 on the screens 26 of the mini camera system 10 according to the present invention. It should also be noted that the necessary wiring may be arranged between the LED light of both the left and right side mini camera system 10 and the control module or button of the vehicle 12 thus allowing for the blinker to work in unison with the turn signal of the motor vehicle and any other methodologies the driver may want, such as signaling a vehicle in the blind spot, etc. It should be noted that the screens 26 may be made of any known material, such as but not limited to glass, plastic, ceramics, composites or metals, etc. It is also contemplated that the user's cell phone may be used to connect via Bluetooth or a wired system to the mini camera system 10 thus allowing for the user to attached their cell phone to the dashboard to act as the screen 26 for the mini camera system 10 of the present invention. It should be noted that the size mentioned above for the housing 18 of the mini camera system 10 may be larger or smaller than that described above, however, it is generally contemplated that it may be a small housing thus reducing the weight and number of components needed to install and operate the mini camera system 10 instead of the outside rearview mirrors of the prior art. It should be noted that the vehicle 12 shown in the drawings includes the passenger side door, the driver's side door, a hood, a body with the necessary quarter panels and the wheels necessary to move the vehicle 12 on a road with the driver controlling the vehicle 12. It should be noted that a person skilled in the art would easily be able to contemplate that such rearview camera system 10 may be used on any type of moving vehicle, not just an automotive vehicle as described herein.

The present invention has been described in an illustrative manner. It is to be understood that the terminology which has been used is intended to be in the nature of words of description rather than that of limitation.

Many modifications and variations of the present invention are possible in light of the above teachings. Therefore, within the scope of the appended claims, the present invention may be practiced otherwise than as specifically described.

What is claimed is:

1. A mini camera system for use on a vehicle, said mini camera system comprising:
a housing secured to a door of the vehicle in place of an existing sideview mirror;
a camera arranged in said housing, said camera positioned to view a side portion and rear portion of the vehicle and an area adjacent thereto; and
a blinker light arranged on the outside of the housing.

2. The mini camera system of claim 1 further comprising a screen arranged on a dashboard or instrument cluster of the vehicle.

3. The mini camera system of claim 2, wherein said screen displays both a left and right outside rear view of the vehicle.

4. The mini camera system of claim 2, wherein said screen is a heads-up display.

5. The mini camera system of claim 2, wherein said screen is integrated in said dashboard of the vehicle or said screen is an add on component to said dashboard.

6. The mini camera system of claim 1, wherein said camera having a concave lens.

7. The mini camera system of claim 1, wherein said camera having a convex lens.

8. The mini camera system of claim 1, wherein said camera is fixed with respect to said housing.

9. The mini camera system of claim 1, wherein said camera moves with respect to said housing.

10. A vehicle without outside rearview mirrors, said vehicle comprising:
a driver side door;
a passenger side door;
a first mini camera housing arranged on an outer surface of said driver side door;
a second mini camera housing arranged on an outer surface of said passenger side door;
a camera arranged in said first housing and said second housing; and
a blinker light arranged on an outside of said first housing and said second housing.

11. The vehicle of claim 10, wherein said camera is positioned to view a side portion and a rear portion of the vehicle.

12. The vehicle of claim 10, wherein said first and said second housing replace existing side rearview mirrors on the vehicle.

13. The vehicle of claim 10 further comprising a screen in communication with said cameras in said housings.

14. The vehicle of claim 13, wherein said screen is arranged as an add on to a dashboard or integrated into an instrument panel of the vehicle.

15. The vehicle of claim 14, wherein said screen displays both a left and right outside rear view of the vehicle.

16. The vehicle of claim 10, wherein said camera having a concave lens or a convex lens.

17. The vehicle of claim 10, wherein said camera is fixed with respect to said first and said second housing.

18. The vehicle of claim 10, wherein said camera moves with respect to said first and said second housing.

19. A method of viewing the side rearview of a vehicle, said method comprising the steps of:
placing a first mini camera system on a surface of the driver door of the vehicle;
placing a second mini camera system on a surface of a passenger door of the vehicle;
arranging a screen in an interior of the vehicle; and
displaying a side rearview of a left and right portion of the vehicle on said screen.

20. The method of claim 19, wherein said first and second mini camera systems replace side rearview mirrors of the vehicle.
